(19) United States
(12) Patent Application Publication
(10) Pub. No.: US 2024/0160346 A1
(43) Pub. Date: May 16, 2024

(54) BACK GESTURE PREVIEW ON COMPUTING DEVICES

(71) Applicant: Google LLC, Mountain View, CA (US)

(72) Inventors: Rohan Ketan Shah, Mountain View, CA (US); Yuan Hang Li, Milpitas, CA (US); Arif Huda, Dallas, TX (US); JT DiMartile, Seattle, WA (US); Nicholas John Bearman, London (GB); Selim Flavio Cinek, Zürich (CH); Shan Huang, Daly City, CA (US); Vadim René Marius Caen, Zürich (CH); Jonas Alon Naimark, San Francisco, CA (US); Ian Lake, Sunnyvale, CA (US); Jorim Dorian Jaggi, Zürich (CH)

(21) Appl. No.: 18/550,663

(22) PCT Filed: Mar. 2, 2023
(86) PCT No.: PCT/US23/63614

§ 371 Date: Sep. 14, 2023

Related U.S. Application Data
(60) Provisional application No. 63/269,007, filed on Mar. 8, 2022.
(60) Provisional application No. 63/378,483, filed on Oct. 5, 2022.

(51) Int. Cl. G06F 3/04883; G06F 3/0483

(52) U.S. Cl. CPC G06F 3/04883; G06F 3/0483

(57) ABSTRACT

An example method includes, outputting, for display by a display device, a graphical user interface of an application executing at a computing device; responsive to receiving an indication of a start of a user input swipe gesture: outputting, for display by the display device and at least partially concealed by the scaled version of the graphical user interface of the application, a visual indication of a result of the user input swipe gesture: and responsive to receiving an indication of a commitment of the user input swipe gesture, outputting, for display by the display device, a graphical user interface that corresponds to the result of the user input swipe gesture.

This application claims the benefit of U.S. Provisional Patent Application No. 63/378,483, filed 5 Oct. 2022, and U.S. Provisional Patent Application No. 63/269,007, filed 8 Mar. 2022, the entire content of each application is incorporated herein by reference.

### BACKGROUND

A computing device may include a display device that displays content from one or more applications executing at the computing device, such as textual or graphical content. A user may wish to “go-back” to view additional portions of the content not presently displayed on the display. For instance, a user may interact with a graphical user interface using a presence-sensitive screen (e.g., touchscreen) of the computing device to go-back to previously displayed content.

### SUMMARY

In general, aspects of this disclosure are directed to techniques that enable a computing device to provide a visual indication of effects of a back gesture. Depending on context, a back gesture (e.g., a swipe from an edge of a display) may have different effects. For instance, responsive to receiving the back gesture while displaying a main page of an application, a computing device may display a home page (e.g., close the application). However, responsive to receiving the back gesture while displaying a sub page of the application, the computing device may display the main page of the application. These different behaviors may be frustrating to a user of the computing device. For instance, the user may become frustrated when the user performs the back gesture with the intent of navigating to a different page of the application and the computing device closes the application. Such an event may cause the user to have to re-launch the application, resulting in increased use of system resources (e.g., processor cycles, memory calls, battery consumption due to extended use, etc.).

In accordance with one or more aspects of this disclosure, a computing device may provide a visual indication of a result of a back gesture before a user commits to the back gesture. For instance, while displaying a page of an application, the computing device may receive a start of a back gesture requesting performance of a back operation (e.g., a swipe gesture). Before performing the back operation, the computing device may display a preview of what will result (e.g., a preview of a resulting graphical user interface) if the back operation is performed. The preview may include a scaled version of the page of the application (e.g., scaled down in size) and the resulting graphical user interface under (e.g., at least partially concealed by) the scaled version of the page of the application. As such, the user will be able to determine whether the back gesture will result in the behavior the user is desiring. If the preview indicates that the behavior is what the user is desiring, the user may commit to the back gesture (e.g., continue the swipe and release their finger or release their finger). On the contrary, if the preview indicates that the behavior is not what the user is desiring, the user may not commit to the back gesture (e.g., release their finger, or un-swipe and then release their finger). In this way, the techniques of this disclosure may reduce user frustration and/or may conserve system resources.

As one example, a method includes outputting, for display by a display device, a graphical user interface of an application executing at a computing device; responsive to receiving, by the computing device, an indication of a start of a user input swipe gesture: outputting, for display by the display device, a visual indication of a result of the user input swipe gesture; and responsive to receiving, by the computing device, an indication of a commitment of the user input swipe gesture, outputting, for display by the display device, a graphical user interface that corresponds to the result of the user input swipe gesture.

As another example, a computing device includes a display device; one or more processors, and a memory that stores instructions that, when executed by the one or more processors, cause the one or more processors to output, for display by the display device, a graphical user interface of an application executing at a computing device; responsive to receiving, via the display device, an indication of a start of a user input swipe gesture: output, for display by the display device, a visual indication of a result of the user input swipe gesture; and responsive to receiving, via the display device, an indication of a commitment of the user input swipe gesture, output, for display by the display device, a graphical user interface that corresponds to the result of the user input swipe gesture.

As another example, a computer-readable storage medium stores instructions that, when executed by one or more processors of a computing device, cause the one or more processors to output, for display by a display device of the computing device, a graphical user interface of an application executing at a computing device; responsive to receiving, via the display device, an indication of a start of a user input swipe gesture: output, for display by the display device, a visual indication of a result of the user input swipe gesture; and responsive to receiving, via the display device, an indication of a commitment of the user input swipe gesture, output, for display by the display device, a graphical user interface that corresponds to the result of the user input swipe gesture.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A-1F are conceptual diagrams illustrating an example computing device configured to provide visual previews of back gesture results, in accordance with one or more aspects of the present disclosure.

FIG. 2 is a block diagram illustrating an example computing device configured to provide visual previews of back gesture results, in accordance with one or more aspects of the present disclosure.

FIG. 3 is a flowchart illustrating example operations for providing visual previews of back gesture results, in accordance with one or more aspects of the present disclosure.

FIGS. 4A-4C are conceptual diagrams illustrating an example of visual previews of back gesture results, in accordance with one or more aspects of the present disclosure.

FIG. 5 is a flowchart illustrating example operations for providing visual previews of back gesture results, in accordance with one or more aspects of the present disclosure.

### DETAILED DESCRIPTION

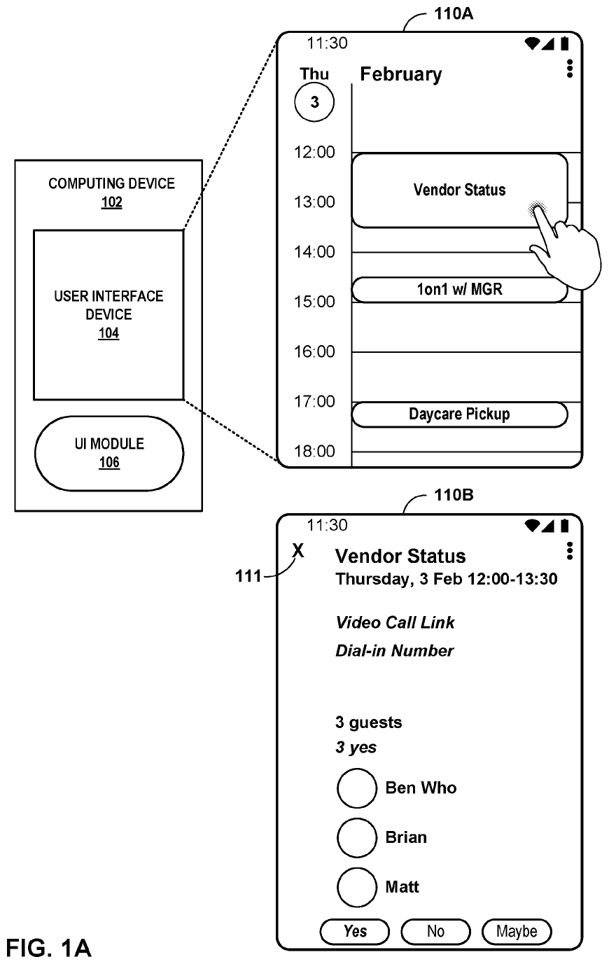

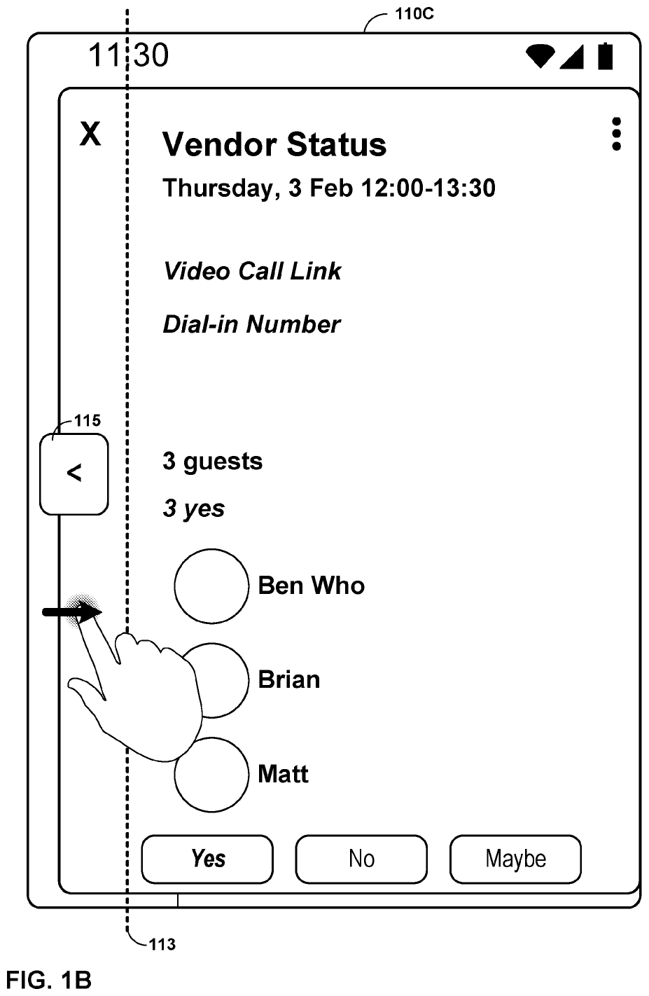

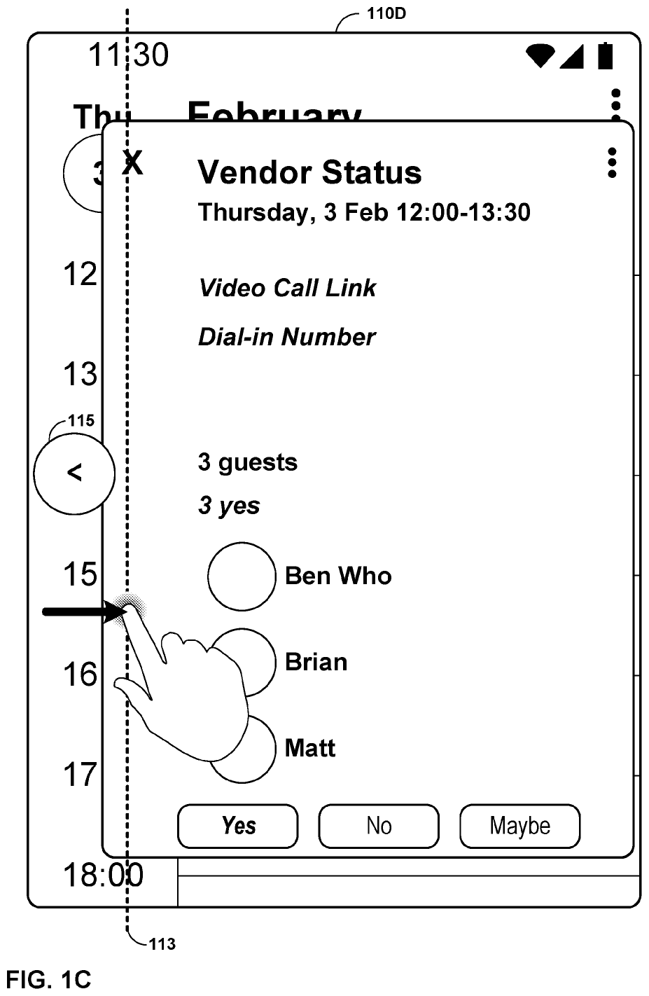

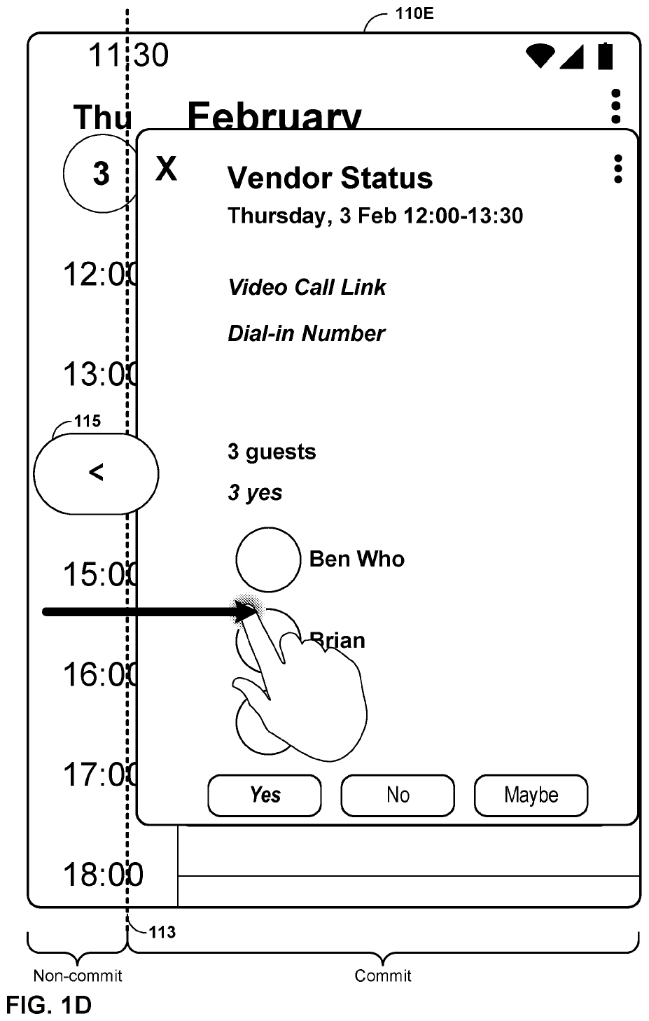

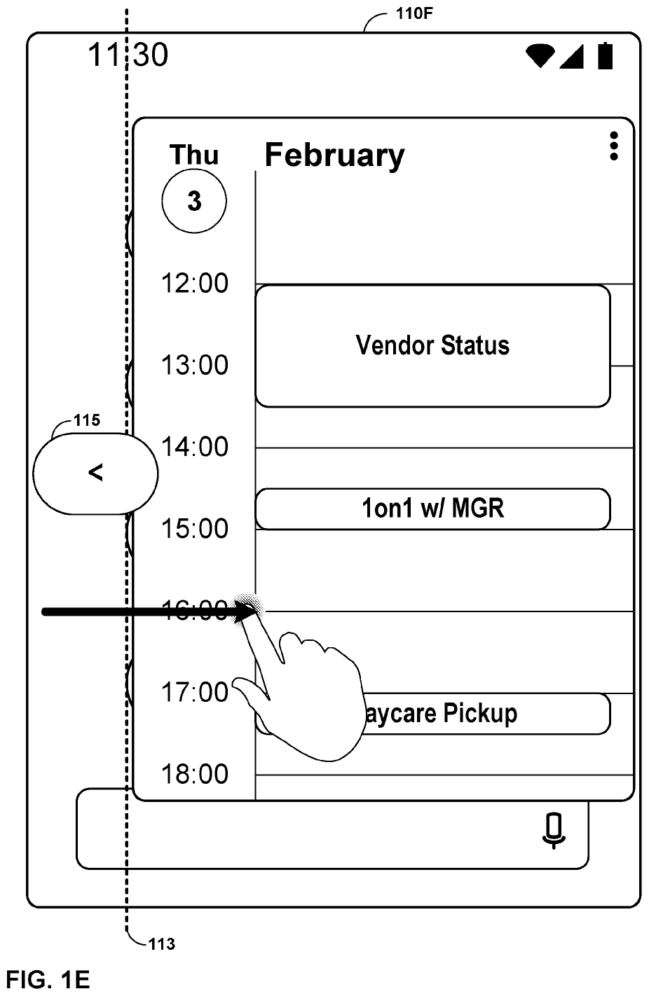

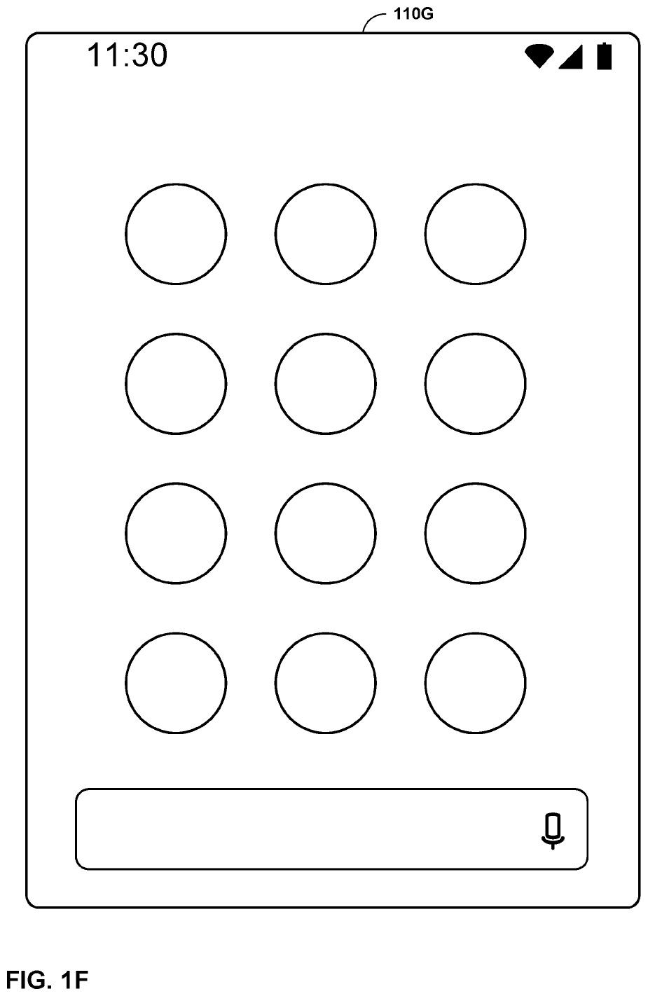

FIGS. 1A-1F is a conceptual diagram illustrating an example computing device 102 configured to provide visual previews of back gesture results, in accordance with one or more aspects of the present disclosure. As shown in FIG. 1A, computing device 102 is a mobile computing device (e.g., a mobile phone). However, in other examples, computing device 102 may be a tablet computer, a laptop computer, a desktop computer, a gaming system, a media player, an e-book reader, a television platform, an automobile navigation system, a wearable computing device (e.g., a computerized watch, computerized headset, computerized eyewear, a computerized glove), or any other type of mobile or non-mobile computing device.

Computing device 102 includes a user interface device (UID) 104. UID 104 of computing device 102 may function as an input device for computing device 102 and as an output device for computing device 102. UID 104 may be implemented using various technologies. For instance, UID 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology. UID 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102.

UID 104 of computing device 102 may include a presence-sensitive display that may receive tactile input from a user of computing device 102. UID 104 may receive indications of the tactile input by detecting one or more gestures from a user of computing device 102 (e.g., the user touching or pointing to one or more locations of UID 104 with a finger or a stylus pen). UID 104 may present output to a user, for instance at a presence-sensitive display. UID 104 may present the output as a graphical user interface (e.g., graphical user interfaces 110A and 110B), which may be associated with functionality provided by computing device 102. For example, UID 104 may present various user interfaces of components of a computing platform, operating system, applications, or services executing at or accessible by computing device 102 (e.g., an electronic message application, an Internet browser application, a mobile operating system, etc.). A user may interact with a respective user interface to cause computing device 102 to perform operations relating to a function.

Computing device 102 includes UI module 106, which manages user interactions with UID 104 and other components of computing device 102. In other words, UI module 106 may act as an intermediary between various components of computing device 102 to make determinations based on user input detected by UID 104 and generate output at UID 104 in response to the user input. UI module 106 may receive instructions from an application, service, platform, or other module of computing device 102 to cause UID 104 to output a user interface (e.g., user interfaces 110). UI module 106 may manage inputs received by computing device 102 as a user views and interacts with the user interface presented at UID 104 and update the user interface in response to receiving additional instructions from the application, service, platform, or other module of computing device 102 that is processing the user input. As such, UI module 106 may cause UID 104 to display graphical user interfaces (GUIs), such as GUIs 110A-110G (collectively “GUIs 110”).

Applications executing at computing device 102 may include several pages. For instance, an application may include a main/home page and several sub-pages (which may have their own sub-pages). For instance, as shown in FIG. 1A, GUI 110A may be a main page of a calendar application executing at computing device 102 and may include graphical elements of several events. To view a sub-page corresponding to a particular event, a user may tap on a graphical element that corresponds to the particular event. For instance, to view a sub-page of the “Vendor Status” event, a user may provide user input to select the graphical element of GUI 110A that corresponds to the “Vendor Status” event (e.g., as shown in FIG. 1A, the user may tap the graphical element of GUI 110A that corresponds to the “Vendor Status” event).

Responsive to receiving the user input to select the graphical element of GUI 110A that corresponds to the “Vendor Status” event, computing device 102 may display GUI 110B, which may be a sub-page that includes further information about the “Vendor Status” event. Once the user has completed viewing/interacting with the sub-page that includes further information about the “Vendor Status” event, the user may provide user input to close the sub-page. For instance, responsive to receiving user input selecting close UI element 111 (e.g., an X), computing device 102 may display GUI 110A (i.e., go-back to the previous page). However, requiring the user to locate and tap close UI element 111 may not be desirable. For instance, different applications may locate close UI element 111 (or similar UI element) in different locations. As such, it may be desirable for computing device 102 to provide the user with the ability to go-back using a common gesture.

One example of a common gesture to go-back (which may also be referred to as a “back gesture”) is for the user to swipe from an edge of UID 104 inwards. However, depending on context, such a back gesture may have different effects. For instance, responsive to receiving the back gesture while displaying the main page of the calendar application, computing device 102 may display a home page (e.g., close the calendar application). However, responsive to receiving the back gesture while displaying a sub page of the application, computing device 102 may display the main page of the application. These different behaviors may be frustrating to a user of computing device 102. For instance, the user may become frustrated when the user performs the back gesture with the intent of navigating to a different page of the calendar application and computing device 102 closes the calendar application. Such an event may cause the user to have to re-launch the calendar application, resulting in increased use of system resources (e.g., processor cycles, memory calls, battery consumption due to extended use, etc.).

In accordance with one or more aspects of this disclosure, computing device 102 may provide a visual indication of a result of a back gesture before a user commits to the back gesture. For instance, while displaying a page of an application (e.g., GUI 110B), computing device 102 may receive a start of a back gesture requesting performance of a back operation (e.g., a swipe gesture). Before performing the back operation, computing device 102 may display a preview of what will result (e.g., a preview of a resulting graphical user interface) if the back operation is performed. The preview may include a scaled version of the page of the application (e.g., scaled down in size) and the resulting graphical user interface under (e.g., at least partially concealed by) the scaled version of the page of the application. As such, the user will be able to determine whether the back gesture will result in the behavior the user is desiring. If the preview indicates that the behavior is what the user is desiring, the user may commit to the back gesture (e.g., release their finger). On the contrary, if the preview indicates that the behavior is not what the user is desiring, the user may not commit to the back gesture (e.g., un-swipe and then release their finger). In this way, the techniques of this disclosure may reduce user frustration and/or may conserve system resources.

FIGS. 1A-1F illustrate a detailed example of the above technique. In general, back gesture recognition may be broken down into three phases: gesture start, result preview, and gesture commitment. In the gesture start phase, computing device 102 may receive an indication of a swipe gesture originating at an edge of UID 104. In the result preview phase, computing device 102 may display a visual preview of the result of gesture commitment. In the gesture commitment phase, computing device 102 may determine whether or not the user committed to the back gesture. Where the user commits to the back gesture, computing device 102 may perform the back operation. On the other hand, where the user does not commit to the back gesture, computing device 102 may remove the visual preview and restore the GUI to the pre-gesture start appearance.

As shown in FIG. 1A, computing device 102 may initially display GUI 110A, which may be a home page of an application. Responsive to receiving user input to navigate to a sub-page of the application, computing device 102 may display the sub-page of the application, shown as GUI 110B. While displaying the sub-page in GUI 110B, computing device 102 may receive an indication of a start of a user input swipe gesture (e.g., the gesture start phase). For instance, computing device 102 may receive an indication of a swipe gesture originating at an edge of UID 104 (illustrated in FIG. 1B as originating at a left edge of UID 104). The swipe gesture may have at least a displacement in a direction perpendicular to the edge (e.g., horizontal in FIG. 1B). In general, the edge may be a vertical edge of UID 104 in an orientation of UID 104 at a time at-which the indication of the start of the user input swipe gesture was received.

Responsive to receiving the indication of the start of the user input swipe gesture, computing device 102 may provide a visual preview of a result of the gesture (e.g., the result preview phase). For instance, UI module 106 may output, for display by UID 104 and in a direction of the user input swipe gesture, a scaled version of the graphical user interface of the application. Furthermore, UI module 106 may output, for display by UID 104 a visual indication of a result of the user input swipe gesture at least partially concealed by the scaled version of the graphical user interface of the application. As shown in the example of FIGS. 1A-1F, the visual indication of the result may be the GUI that will be displayed responsive to computing device 102 determining that the user has committed to the user input swipe gesture.

As discussed above, UI module 106 may output the scaled version of the graphical user interface of the application in a direction of the user input swipe gesture. For instance, as shown in the example of FIGS. 1B-1D where the user input swipe gesture is from left to right, UI module 106 may output the scaled version of the graphical user interface of the application on a right side of UID 104 (e.g., as the direction of the gesture is to the right). Similarly, where a user input gesture is from right to left, UI module 106 may output the scaled version of the graphical user interface of the application on a left side of UID 104. In some examples, in addition to a horizontal location of the scaled version (e.g., on the right where the gesture is left to right), UI module 106 may adjust a vertical location of the scaled version based on a vertical displacement of the gesture (e.g., displacement in a direction parallel to the edge at which the swipe gesture started).

In some examples, the result of the user input swipe gesture may be a return to a previous page of an application (e.g., from another page of the application). For instance, where computing device 102 receives the user input swipe gesture while displaying a sub-page of an application (e.g., while displaying GUI 110B), the result of the user input swipe gesture may be a previous page of the application (e.g., a return to GUI 10A). In such cases, the visual indication of the result of the user input swipe gesture may be a graphical user interface of the previous page. In particular, as can be seen in FIGS. 1B-1D, computing device 102 may display GUI of the previous page (e.g., GUI 110A) at least partially under/concealed by the scaled GUI of the application. For example, computing device 102 may display a shrunken version of the current page of the application over a full-size version of the previous page.

In some examples, the result of the user input swipe gesture may be a return to a home page of an operating system of computing device 102 (e.g., from a home page of an application). For instance, where computing device 102 receives the user input swipe gesture while displaying a main/home page of an application (e.g., while displaying GUI 110A), the result of the user input swipe gesture may be a home page of an operating system of computing device 102 (e.g., to GUI 110G). In such cases, the visual indication of the result of the user input swipe gesture may be a graphical user interface of the home page. In particular, as can be seen in FIGS. 1E and 1F, computing device 102 may display GUI of the home page (e.g., GUI 110G) at least partially under/concealed by the scaled GUI of the home page of the application (e.g., as shown in FIG. 1E). For example, computing device 102 may display a shrunken version of the home page of the application over a full-size version of the home page of the operating system of computing device 102.

Computing device 102 may determine whether or not the user has committed to the back gesture (e.g., the gesture commitment phase). In some examples, computing device 102 may determine whether or not the user has committed to the back gesture based on a location on UID 104 at which the user input swipe gesture terminates (e.g., where the user lifts their finger). For instance, where UI module 106 determines that the user input swipe gesture terminated with a displacement in the direction perpendicular to the edge that is greater than a commitment threshold (e.g., commitment threshold 113), UI module 106 may determine that the user committed to the gesture (e.g., receive an indication of a commitment of the user input swipe gesture). On the other hand, where UI module 106 determines that the user input swipe gesture terminated with a displacement in the direction perpendicular to the edge that is not greater than the commitment threshold (e.g., commitment threshold 113), UI module 106 may determine that the user did not commit to the gesture (e.g., receive an indication of a non-commitment of the user input swipe gesture).

Responsive to determining that the user has committed to the back gesture (e.g., responsive to receiving an indication of a commitment of the user input swipe gesture), computing device 102 may perform the back operation by displaying a GUI that corresponds to the visual indication. For instance, responsive to determining that the user released the user input swipe gesture at the point indicated on FIG. 1D (e.g., on the commit side of commitment threshold 113), computing device 102 may display GUI 110A (e.g., that corresponds to the result shown at least partially concealed in FIG. 1D). Similarly, responsive to determining that the user released the user input swipe gesture at the point indicated on FIG. 1E (e.g., on the non-commit side of commitment threshold 113), computing device 102 may display GUI 110G (e.g., that corresponds to the result shown at least partially concealed in FIG. 1E).

Responsive to determining that the user has non-committed the back gesture (e.g., responsive to receiving an indication of a non-commitment of the user input swipe gesture), computing device 102 may undo the scaling by displaying a GUI that corresponds to an unscaled version of the application. For instance, responsive to determining that the user released the user input swipe gesture at the point indicated on FIG. 1B (e.g., on the non-commit side of commitment threshold 113), computing device 102 may display GUI 110B.

In some examples, computing device 102 may provide output to the user indicating whether release of the user input gesture will be interpreted as commitment to the user input swipe gesture. As one example, computing device 102 may provide haptic feedback that indicates when the displacement of the swipe gesture in the direction perpendicular to the edge crosses commitment threshold 113. Computing device 102 may provide the haptic feedback when the swipe gesture crosses from the non-commitment side to the commitment side of commitment threshold 113 (sides labeled in FIG. 1D). Additionally or alternatively, computing device 102 may provide the haptic feedback when the swipe gesture crosses from the commitment side to the non-commitment side of commitment threshold 113.

In some examples, computing device 102 may output, via UID 104, a graphical element indicating that a back gesture is being recognized. For instance, as shown in FIGS. 1B-1E, computing device 102 may output graphical element 115 proximate to the edge at which the indication of the start of the user input swipe gesture was received. As another example of feedback, computing device 102 may adjust, based on whether release of the user input swipe gesture will commit, an appearance of graphical element 115. For instance, as shown in FIG. 1B where release of the user input swipe gesture at the point illustrated will not commit, computing device 102 may display graphical element 115 as being a rectangle with rounded corners. Responsive to the user input gesture reaching commitment threshold 113, computing device 102 may modify the appearance of graphical element 115. For instance, as shown in FIG. 1C, computing device 102 may change graphical element 115 from a rectangle into a circle. As shown in FIG. 1D, as the user input gesture continues further into the commitment side, computing device 102 may stretch graphical element 115 (e.g., into a discorectangle shape with a length positively correlated with a displacement of the gesture).

As discussed above, at least during the result preview phase, computing device 102 may display a scaled version of the graphical user interface of an application. In some examples, the scaled version of the GUI of the application may be a reduced size (e.g., shrunken) version of the GUI of the application. Computing device 102 may generate the scaled version of the GUI of the application based on a scaling factor. In some examples, the scaling factor may be a static variable (e.g., the scaled version may always be 80% of full size). In other examples, computing device 102 may dynamically determine the scaling factor based on characteristics of the swipe gesture. For instance, computing device 102 may determine, based on the displacement of the swipe gesture in the direction perpendicular to the edge, the scaling factor (e.g., such that the scaling factor is positively correlated with the displacement). In some examples, computing device 102 may determine the scaling factor as a linear function of the displacement. In other examples, computing device 102 may determine the scaling factor as a non-linear function of the displacement (e.g., the influence of the displacement on the scaling factor may decrease exponentially).

Techniques of this disclosure may provide one or more technical benefits. For example, by providing a preview of a result of a back gesture, a user may avoid unintended page navigation and/or application closing, thereby saving processor cycles and power.

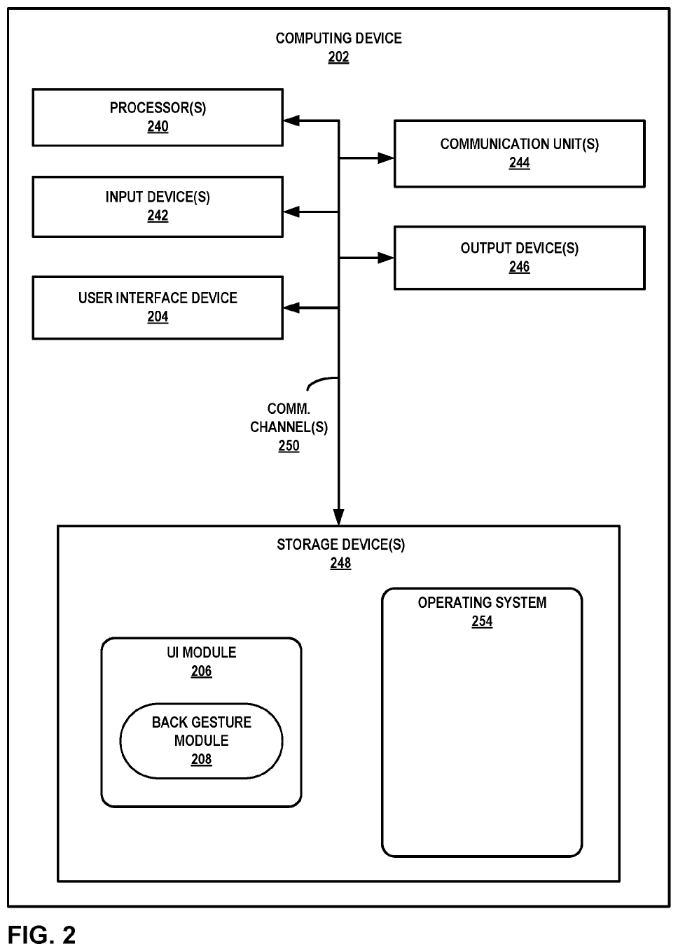

FIG. 2 is a block diagram illustrating an example computing device 202, in accordance with one or more aspects of the present disclosure. Computing device 202 of FIG. 2 is an example of computing device 102 of FIG. 1A. Computing device 202 is only one particular example of computing device 102 of FIG. 1A, and many other examples of computing device 102 may be used in other instances. In the example of FIG. 2, computing device 202 may be a wearable computing device, a mobile computing device (e.g., a smartphone), or any other computing device. Computing device 202 of FIG. 2 may include a subset of the components included in example computing device 202 or may include additional components not shown in FIG. 2.

As shown in the example of FIG. 2, computing device 202 includes user interface device 204 (“UID 204”), one or more processors 240, one or more input devices 242, one or more communication units 244, one or more output devices 246, and one or more storage devices 248. Storage devices 248 of computing device 202 also include operating system 254 and UI module 206.

Communication channels 250 may interconnect each of the components 240, 242, 244, 246, 248, 204, and 214 for inter-component communications (physically, communicatively, and/or operatively). In some examples, communication channels 250 may include a system bus, a network connection, an inter-process communication data structure, or any other method for communicating data.

One or more input devices 242 of computing device 202 may be configured to receive input. Examples of input are tactile, audio, and video input. Input devices 242 of computing device 202, in one example, includes a presence-sensitive display, touch-sensitive screen, mouse, keyboard, voice responsive system, video camera, microphone or any other type of device for detecting input from a human or machine.

One or more output devices 246 of computing device 202 may be configured to generate output. Examples of output are tactile, audio, and video output. Output devices 246 of computing device 202, in one example, includes a presence-sensitive display, sound card, video graphics adapter card, speaker, cathode ray tube (CRT) monitor, liquid crystal display (LCD), or any other type of device for generating output to a human or machine.

One or more communication units 244 of computing device 202 may be configured to communicate with external devices via one or more wired and/or wireless networks by transmitting and/or receiving network signals on the one or more networks. Examples of communication unit 244 include a network interface card (e.g., such as an Ethernet card), an optical transceiver, a radio frequency transceiver, a GPS receiver, or any other type of device that can send and/or receive information. Other examples of communication units 44 may include short wave radios, cellular data radios, wireless network radios, as well as universal serial bus (USB) controllers.

One or more storage devices 248 within computing device 202 may store information for processing during operation of computing device 202. In some examples, storage device 248 is a temporary memory, meaning that a primary purpose of storage device 248 is not long-term storage. Storage devices 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 248, in some examples, also include one or more computer-readable storage media. Storage devices 248 may be configured to store larger amounts of information than volatile memory. Storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or information (e.g., data) associated with UI module 206, back gesture module 208, and operating system 254.

One or more processors 240 may implement functionality and/or execute instructions within computing device 202. For example, processors 240 on computing device 202 may receive and execute instructions stored by storage devices 248 that execute the functionality of UI module 206 and back gesture module 208. These instructions executed by processors 240 may cause UI module 206 of computing device 202 to provide a visual indication of effects of a back gesture as described herein.

In some examples, UID 204 of computing device 202 may include functionality of input devices 242 and/or output devices 246. In the example of FIG. 2, UID 204 may be or may include a presence-sensitive input device. In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x,y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, a presence sensitive input device also provides output to a user using tactile, audio, or video stimuli as described with respect to output device 246, e.g., at a display. In the example of FIG. 2, UID 204 may present a user interface.

While illustrated as an internal component of computing device 202, UID 204 also represents an external component that shares a data path with computing device 202 for transmitting and/or receiving input and output. For instance, in one example, UID 204 represents a built-in component of computing device 202 located within and physically connected to the external packaging of computing device 202 (e.g., a screen on a mobile phone). In another example, UID 204 represents an external component of computing device 202 located outside and physically separated from the packaging of computing device 202 (e.g., a monitor, a projector, etc. that shares a wired and/or wireless data path with a tablet computer).

UI module 206 may include all functionality of UI module 106 of computing device 102 of FIG. 1 and may perform similar operations as UI module 106 for managing a user interface (e.g., user interfaces 110) that computing device 202 provides at UID 204. For example, UI module 206 of computing device 202h may include back gesture module 208 that provides a visual indication of effects of a back gesture, as discussed above with respect to FIGS. 1A-1F.

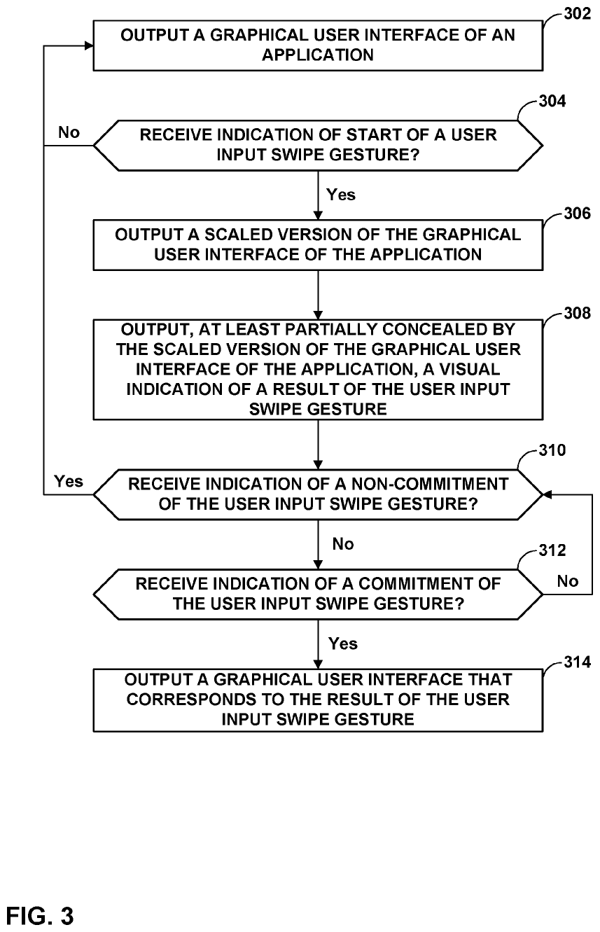

FIG. 3 is a flowchart illustrating example operations for stretching content, in accordance with one or more aspects of the present disclosure. For purposes of illustration only, the example operations are described below within the context of GUIs 110 of FIGS. 1A-1F and computing device 202 of FIG. 2.

Computing device 102 may output a graphical user interface of a page of an application (302). For instance. UI module 106 may cause UID 104 to display a sub-page of a calendar (e.g., GUI 110B of FIG. 1A).

Computing device 102 may monitor for receipt of an indication of a start of a user input swipe gesture (304). For instance, UID 104 may generate (e.g., via a touch or presence sensitive screen) user input data. UI module 106 may process the user input data and, responsive to the user input data indicating a swipe of a user's finger originating at an edge of UID 104, generate the indication of the start of a user input swipe gesture. Where the indication of the start of the user input swipe gesture is not received (“No” branch of 304), computing device 102 may continue to output the graphical user interface of the application (302).

Responsive to receiving the indication of the start of the user input swipe gesture (“Yes” branch of 304), computing device 102 may output a scaled version of the graphical user interface of the application (306) and output, at least partially concealed by the scaled version of the graphical user interface of the application, a visual indication of a result of the user input swipe gesture (308). As discussed above, the visual indication may be a preview of what will be displayed if the user commits to the swipe gesture. For instance. UI module 106 may cause UID 104 to display GUI 110C of FIG. 1B. As discussed above, in some examples, a scaling factor used to generate the scaled version may be based on a displacement of the swipe gesture. For instance, as the user's finger travels farther right along UID 104, UI module 106 may further reduce a size of the scaled version (e.g., as shown in FIGS. 1B-1D).

As discussed above, a user can commit to, or non-commit, the swipe gesture. Computing device 102 may determine whether or not the user committed to the swipe gesture based on a location on UID 104 at which the user ended the swipe gesture (e.g., removed their finger from UID 104). Responsive to receiving an indication of a non-commitment of the user input swipe gesture (“Yes” branch of 310), computing device 102 may remove the scaling and output the (unscaled) graphical user interface of the application (e.g., as was displayed prior to receiving the indication of the start of the user input swipe gesture) (302). Responsive to receiving an indication of a commitment of the user input swipe gesture (“Yes” branch of 312), computing device 102 may perform the back action and display a graphical user interface that corresponds to the result of the user input swipe gesture (314). For instance, UI module 106 may cause UID 104 to display the graphical user interface that was concealed by the scaled version (e.g., remove the scaled version from the display).

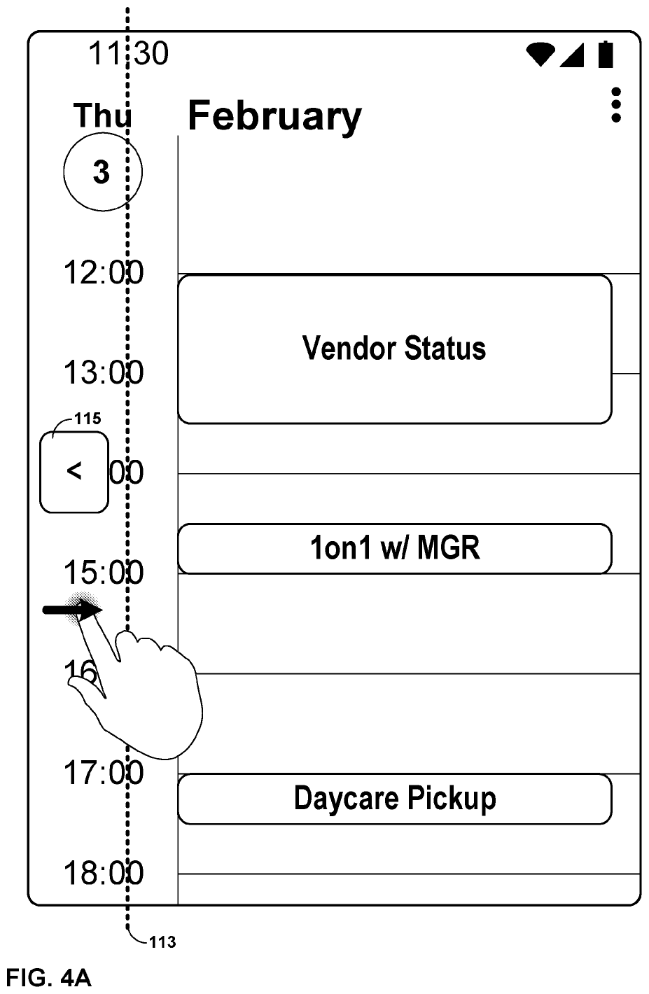

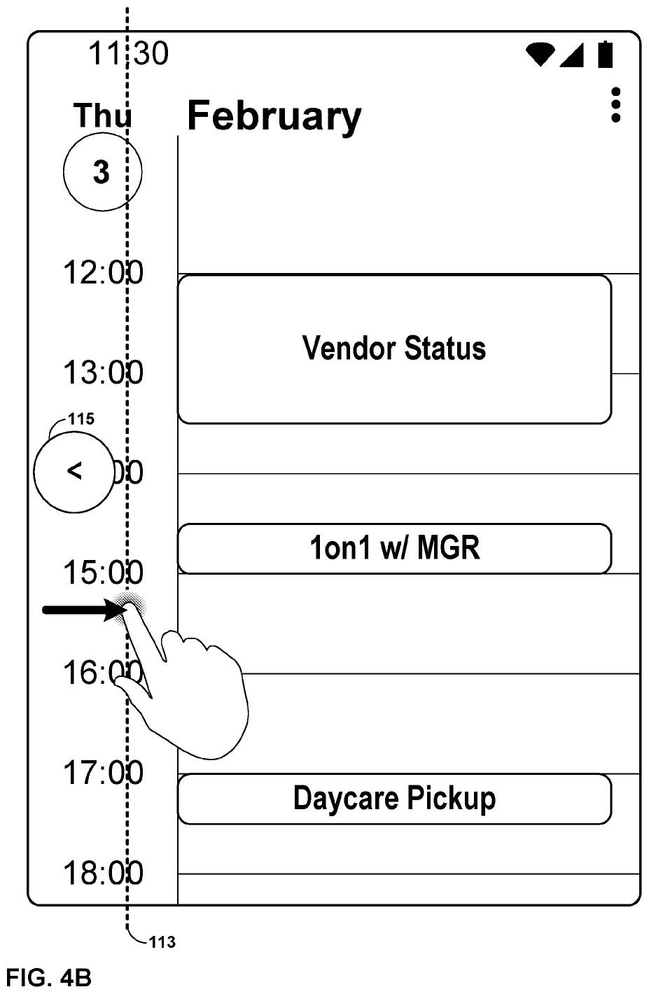

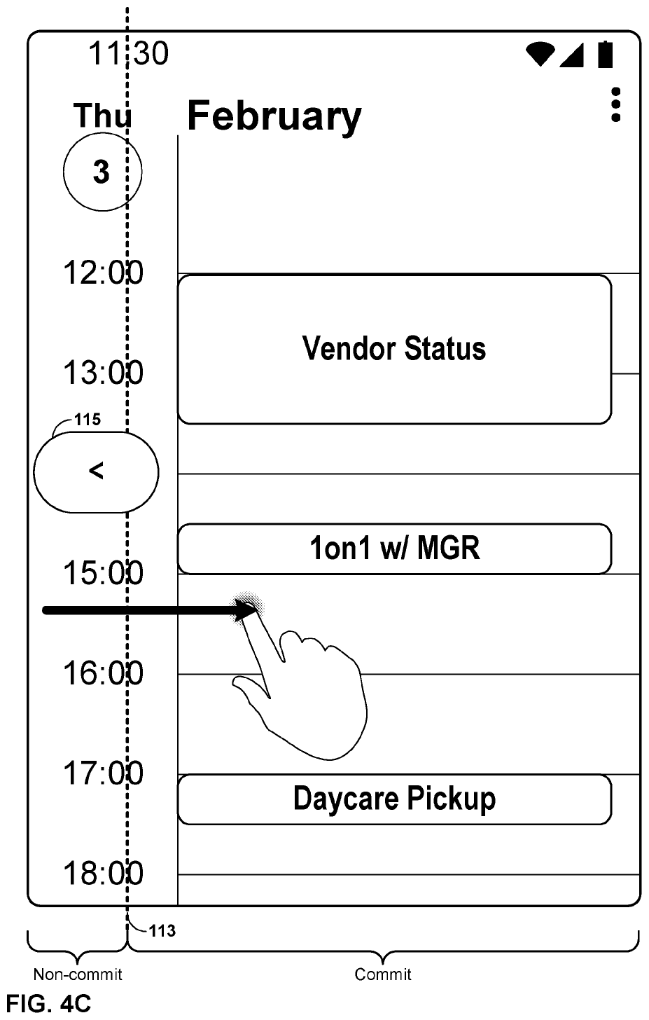

FIGS. 4A-4C (combined with FIG. 1A) illustrate another detailed example of the above technique. In general, back gesture recognition may be broken down into three phases: gesture start, result preview, and gesture commitment. In the gesture start phase, computing device 102 may receive an indication of a swipe gesture originating at an edge of UID 104. In the result preview phase, computing device 102 may display a visual preview of the result of gesture commitment. In the gesture commitment phase, computing device 102 may determine whether or not the user committed to the back gesture. Where the user commits to the back gesture, computing device 102 may perform the back operation. On the other hand, where the user does not commit to the back gesture, computing device 102 may remove the visual preview and restore the GUI to the pre-gesture start appearance.

As shown in FIG. 1A, computing device 102 may initially display GUI 110A, which may be a home page of an application. Responsive to receiving user input to navigate to a sub-page of the application, computing device 102 may display the sub-page of the application, shown as GUI 110B. While displaying the sub-page in GUI 110B, computing device 102 may receive an indication of a start of a user input swipe gesture (e.g., the gesture start phase). For instance, computing device 102 may receive an indication of a swipe gesture originating at an edge of UID 104 (illustrated in FIG. 1B as originating at a left edge of UID 104). The swipe gesture may have at least a displacement in a direction perpendicular to the edge (e.g., horizontal in FIG. 1B). In general, the edge may be a vertical edge of UID 104 in an orientation of UID 104 at a time at-which the indication of the start of the user input swipe gesture was received.

Responsive to receiving the indication of the start of the user input swipe gesture, computing device 102 may provide a visual preview of a result of the gesture (e.g., the result preview phase). For instance, UI module 106 may output, for display by UID 104 and in a direction of the user input swipe gesture, a scaled version of the graphical user interface of the application. Furthermore, UI module 106 may output, for display by UID 104 a visual indication of a result of the user input swipe gesture at least partially concealed by the scaled version of the graphical user interface of the application. As shown in the example of FIGS. 1A, 4A, and 4B, the visual indication of the result may be the GUI that will be displayed responsive to computing device 102 determining that the user has committed to the user input swipe gesture.

In some examples, UI module 106 may omit or otherwise adjust output of the scaled version of the graphical user interface of the application in the direction of the user input. For instance, as shown in the example of FIGS. 4A-4C, UI module 106 may not output a scaled version of the graphical user interface of the application.

In some examples, the result of the user input swipe gesture may be a return to a previous page of an application (e.g., from another page of the application). For instance, where computing device 102 receives the user input swipe gesture while displaying a sub-page of an application (e.g., while displaying GUI 110B), the result of the user input swipe gesture may be a previous page of the application (e.g., a return to GUI 110A). In such cases, the visual indication of the result of the user input swipe gesture may be a graphical user interface of the previous page. In particular, as can be seen in FIGS. 4A-4C, computing device 102 may display GUI of the previous page (e.g., GUI 110A).

In some examples, computing device 102 may output the visual indication of the result with a visual modification (e.g., as compared to the actual result). For instance, computing device 102 may adjust one or more of a brightness, scaling, position, contrast, color, color scheme (e.g., grayscale vs. color), etc. of the visual indication of the result. As one specific example, computing device 102 may output the visual indication of the result as a scaled down version of the result. Computing device 102 may output the visual indication with the visual modification regardless of whether or not the scaled version of the application is displayed.

Computing device 102 may determine whether or not the user has committed to the back gesture (e.g., the gesture commitment phase). In some examples, computing device 102 may determine whether or not the user has committed to the back gesture based on a location on UID 104 at which the user input swipe gesture terminates (e.g., where the user lifts their finger). For instance, where UI module 106 determines that the user input swipe gesture terminated with a displacement in the direction perpendicular to the edge that is greater than a commitment threshold (e.g., commitment threshold 113). UI module 106 may determine that the user committed to the gesture (e.g., receive an indication of a commitment of the user input swipe gesture). On the other hand, where UI module 106 determines that the user input swipe gesture terminated with a displacement in the direction perpendicular to the edge that is not greater than the commitment threshold (e.g., commitment threshold 113), UI module 106 may determine that the user did not commit to the gesture (e.g., receive an indication of a non-commitment of the user input swipe gesture).

Responsive to determining that the user has committed to the back gesture (e.g., responsive to receiving an indication of a commitment of the user input swipe gesture), computing device 102 may perform the back operation by displaying a GUI that corresponds to the visual indication. For instance, responsive to determining that the user released the user input swipe gesture at the point indicated on FIG. 4C (e.g., on the commit side of commitment threshold 113), computing device 102 may display GUI 110A (e.g., that corresponds to the result shown at least partially concealed in FIG. 4C).

Responsive to determining that the user has non-committed the back gesture (e.g., responsive to receiving an indication of a non-commitment of the user input swipe gesture), computing device 102 may undo the scaling by displaying a GUI that corresponds to an unsealed version of the application. For instance, responsive to determining that the user released the user input swipe gesture at the point indicated on FIG. 4A (e.g., on the non-commit side of commitment threshold 113), computing device 102 may display GUI 110B.

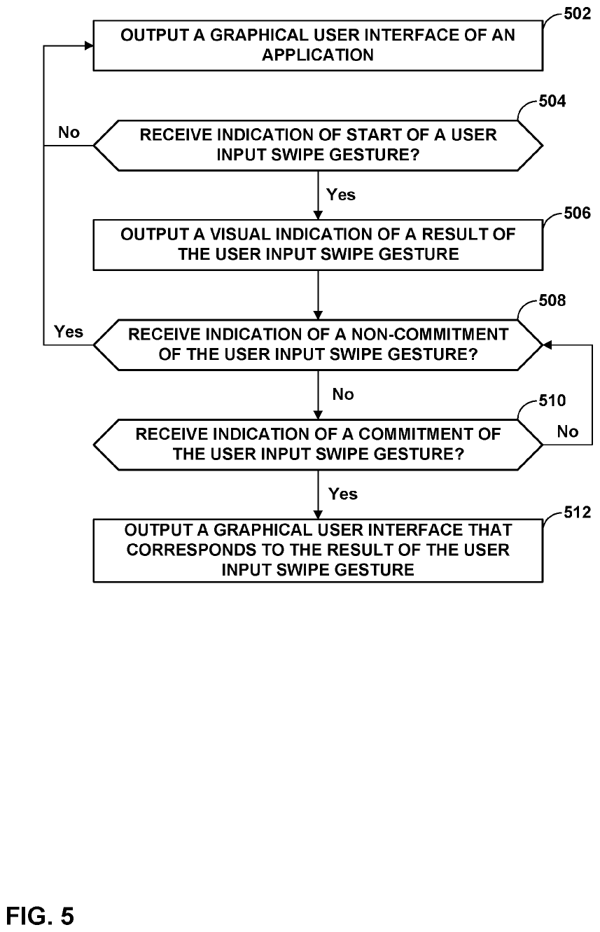

FIG. 5 is a flowchart illustrating example operations for stretching content, in accordance with one or more aspects of the present disclosure. For purposes of illustration only, the example operations are described below within the context of FIGS. 1A and 4A-4C and computing device 202 of FIG. 2.

Computing device 102 may output a graphical user interface of a page of an application (502). For instance, UI module 106 may cause UID 104 to display a sub-page of a calendar (e.g., GUI 110B of FIG. 1A).

Computing device 102 may monitor for receipt of an indication of a start of a user input swipe gesture (504). For instance, UID 104 may generate (e.g., via a touch or presence sensitive screen) user input data. UI module 106 may process the user input data and, responsive to the user input data indicating a swipe of a user's finger originating at an edge of UID 104, generate the indication of the start of a user input swipe gesture. Where the indication of the start of the user input swipe gesture is not received (“No” branch of 504), computing device 102 may continue to output the graphical user interface of the application (302).

Responsive to receiving the indication of the start of the user input swipe gesture (“Yes” branch of 504), computing device 102 may output a visual indication of a result of the user input swipe gesture (506). As discussed above, the visual indication may be a preview of what will be displayed if the user commits to the swipe gesture. For instance. UI module 106 may cause UID 104 to display GUI 110C of FIG. 1B.

As discussed above, a user can commit to, or non-commit, the swipe gesture. Computing device 102 may determine whether or not the user committed to the swipe gesture based on a location on UID 104 at which the user ended the swipe gesture (e.g., removed their finger from UID 104). Responsive to receiving an indication of a non-commitment of the user input swipe gesture (“Yes” branch of 508), computing device 102 may the graphical user interface of the application (e.g., as was displayed prior to receiving the indication of the start of the user input swipe gesture) (502). Responsive to receiving an indication of a commitment of the user input swipe gesture (“Yes” branch of 510), computing device 102 may perform the back action and display a graphical user interface that corresponds to the result of the user input swipe gesture (512).

The following numbered examples may illustrate one or more aspects of this disclosure:

Example 1. A method comprising: outputting, for display by a display device, a graphical user interface of an application executing at a computing device; responsive to receiving, by the computing device, an indication of a start of a user input swipe gesture: outputting, for display by the display device and in a direction of the user input swipe gesture, a scaled version of the graphical user interface of the application; and outputting, for display by the display device and at least partially concealed by the scaled version of the graphical user interface of the application, a visual indication of a result of the user input swipe gesture; and responsive to receiving, by the computing device, an indication of a commitment of the user input swipe gesture, outputting, for display by the display device, a graphical user interface that corresponds to the result of the user input swipe gesture.

Example 2. The method of example 1, wherein the graphical user interface of the application comprises a current page of the application, and wherein the graphical user interface that corresponds to the result of the user input swipe gesture comprises a previous page of the application.

Example 3. The method of example 1, wherein the graphical user interface of the application comprises a home page of the application, and wherein the graphical user interface that corresponds to the result of the user input swipe gesture comprises a home page of an operating system of the computing device.

Example 4. The method of example 1, wherein receiving the indication of the start of the user input swipe gesture comprises: receiving an indication of a swipe gesture originating at an edge of the display device, the swipe gesture having at least a displacement in a direction perpendicular to the edge.

Example 5. The method of example 4, wherein the edge is a vertical edge of the display device in an orientation of the display device at a time at-which the indication of the start of the user input swipe gesture was received.

Example 6. The method of example 4, further comprising: determining whether the displacement of the swipe gesture in the direction perpendicular to the edge is greater than a commitment threshold, wherein receiving the indication of the commitment of the user input swipe gesture comprises receiving, by the computing device, an indication that the user input swipe gesture has been released while the displacement of the swipe gesture in the direction perpendicular to the edge is greater than the commitment threshold.

Example 7. The method of example 6, further comprising: generating, by the computing device, haptic feedback that indicates when the displacement of the swipe gesture in the direction perpendicular to the edge crosses the commitment threshold.

Example 8. The method of example 4, further comprising: responsive to receiving, by the computing device, the indication of the start of the user input swipe gesture: outputting, for display by the display device and proximate to the edge, a graphical element indicating that a back gesture is being recognized.

Example 9. The method of example 8, wherein outputting the graphical element indicating that the back gesture is being recognized comprises: adjusting, based on whether release of the user input swipe gesture will commit, an appearance of the graphical element.

Example 10. The method of example 9, wherein determining that release of the user input swipe gesture will commit comprises determining that the displacement of the swipe gesture in the direction perpendicular to the edge is greater than a commitment threshold.

Example 11. The method of example 4, wherein outputting the scaled version of the graphical user interface of the application comprises: determining, based on the displacement of the swipe gesture in the direction perpendicular to the edge, a scaling factor; and generating, based on the scaling factor, the scaled version of the graphical user interface of the application.

Example 12. The method of example 11, wherein determining the scaling factor comprises: determining, as a non-linear function of the displacement of the swipe gesture in the direction perpendicular to the edge, the scaling factor.

Example 13. The method of example 1, further comprising: responsive to receiving, by the computing device, an indication of a non-commitment of the user input swipe gesture, outputting, for display by the display device, an unscaled version of the graphical user interface of the application.

Example 14. A computing device comprising: a display device: one or more processors; and a memory that stores instructions that, when executed by the one or more processors, cause the one or more processors to perform the method of examples 1-13.

Example 15. A computing device comprising means for performing any of the methods of examples 1-13.

Example 16. A non-transitory computer-readable storage medium storing instructions that, when executed by one or more processors of a computing device, cause the one or more processors to perform any of the methods of examples 1-13.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
outputting, for display by a display device, a graphical user interface of an application executing at a computing device; and
responsive to receiving, by the computing device, an indication of a start of a user input swipe gesture:
outputting, for display by the display device, a visual indication of a result of the user input swipe gesture; and
responsive to receiving, by the computing device, an indication of a commitment of the user input swipe gesture, outputting, for display by the display device, a graphical user interface that corresponds to the result of the user input swipe gesture.

2. The method of claim 1, wherein the graphical user interface of the application comprises a current page of the application, and wherein the graphical user interface that corresponds to the result of the user input swipe gesture comprises a previous page of the application.

3. The method of claim 1, wherein the graphical user interface of the application comprises a home page of the application, and wherein the graphical user interface that corresponds to the result of the user input swipe gesture comprises a home page of an operating system of the computing device.

4. The method of claim 1, wherein receiving the indication of the start of the user input swipe gesture comprises:
receiving an indication of a swipe gesture originating at an edge of the display device, the swipe gesture having at least a displacement in a direction perpendicular to the edge.

5. The method of claim 4, wherein the edge is a vertical edge of the display device in an orientation of the display device at a time at-which the indication of the start of the user input swipe gesture was received.

6. The method of claim 4, further comprising:
determining whether the displacement of the swipe gesture in the direction perpendicular to the edge is greater than a commitment threshold,
wherein receiving the indication of the commitment of the user input swipe gesture comprises receiving, by the computing device, an indication that the user input swipe gesture has been released while the displacement of the swipe gesture in the direction perpendicular to the edge is greater than the commitment threshold.

7. The method of claim 6, further comprising:
generating, by the computing device, haptic feedback that indicates when the displacement of the swipe gesture in the direction perpendicular to the edge crosses the commitment threshold.

8. The method of claim 4, further comprising:
responsive to receiving, by the computing device, the indication of the start of the user input swipe gesture:
outputting, for display by the display device and proximate to the edge, a graphical element indicating that a back gesture is being recognized.

9. The method of claim 8, wherein outputting the graphical element indicating that the back gesture is being recognized comprises:
adjusting, based on whether release of the user input swipe gesture will commit, an appearance of the graphical element.

10. The method of claim 9, wherein determining that release of the user input swipe gesture will commit comprises determining that the displacement of the swipe gesture in the direction perpendicular to the edge is greater than a commitment threshold.

11. The method of claim 1, further comprising:
responsive to receiving, by the computing device, the indication of the start of the user input swipe gesture outputting, for display by the display device and in a direction of the user input swipe gesture, a scaled version of the graphical user interface of the application,
wherein outputting the visual indication of the result of the user input swipe gesture comprises outputting, for display by the display device and at least partially concealed by the scaled version of the graphical user interface of the application, the visual indication of the result of the user input swipe gesture.

12. The method of claim 11, further comprising:
responsive to receiving, by the computing device, an indication of a non-commitment of the user input swipe gesture, outputting, for display by the display device, an unscaled version of the graphical user interface of the application.

13. The method of claim 11, wherein receiving the indication of the start of the user input swipe gesture comprises:
receiving an indication of a swipe gesture originating at an edge of the display device, the swipe gesture having at least a displacement in a direction perpendicular to the edge, wherein outputting the scaled version of the graphical user interface of the application comprises:
determining, based on the displacement of the swipe gesture in the direction perpendicular to the edge, a scaling factor; and
generating, based on the scaling factor, the scaled version of the graphical user interface of the application.

14. The method of claim 13, wherein determining the scaling factor comprises:
determining, as a non-linear function of the displacement of the swipe gesture in the direction perpendicular to the edge, the scaling factor.

15. A computing device comprising:
a display device;
one or more processors; and
a memory that stores instructions that, when executed by the one or more processors, cause the one or more processors to:
output, for display by the display device, a graphical user interface of an application executing at a computing device; and
responsive to receiving an indication of a start of a user input swipe gesture:
output, for display by the display device, a visual indication of a result of the user input swipe gesture; and
responsive to receiving an indication of a commitment of the user input swipe gesture, output, for display by the display device, a graphical user interface that corresponds to the result of the user input swipe gesture.

16. (canceled)

17. (canceled)

18. The computing device of claim 15,
wherein the instructions that cause the one or more processors to receive the indication of the start of the user input swipe gesture comprise instructions that cause the one or more processors to receive an indication of a swipe gesture originating at an edge of the display device, the swipe gesture having at least a displacement in a direction perpendicular to the edge,
wherein the instructions that cause the one or more processors to receive the indication of the commitment of the user input swipe gesture comprise instructions that cause the one or more processors to receive an indication that the user input swipe gesture has been released while a displacement of the swipe gesture in the direction perpendicular to the edge is greater than a commitment threshold.

19. The computing device of claim 15, further comprising instructions that cause the one or more processors to:
output, responsive to receiving the indication of the start of the user input swipe gesture outputting, for display by the display device and in a direction of the user input swipe gesture, a scaled version of the graphical user interface of the application,
wherein the instructions that cause the one or more processors to output the visual indication of the result of the user input swipe gesture comprise instructions that cause the one or more processors to output, for display by the display device and at least partially concealed by the scaled version of the graphical user interface of the application, the visual indication of the result of the user input swipe gesture.

20. The computing device of claim 15, further comprising instructions that cause the one or more processors to:
responsive to receiving an indication of a non-commitment of the user input swipe gesture, output, for display by the display device, an unscaled version of the graphical user interface of the application.

21. A non-transitory computer-readable storage medium storing instructions that, when executed by one or more processors of a computing device, cause the one or more processors to:
output, for display by a display device, a graphical user interface of an application executing at a computing device; and
responsive to receiving an indication of a start of a user input swipe gesture:
output, for display by the display device, a visual indication of a result of the user input swipe gesture; and
responsive to receiving an indication of a commitment of the user input swipe gesture, output, for display by the display device, a graphical user interface that corresponds to the result of the user input swipe gesture.
